(19) United States
(12) Patent Application Publication
(10) Pub. No.: US 2020/0401996 A1
(43) Pub. Date: Dec. 24, 2020

(54) INTEGRATED AGRICULTURE INFORMATION AND MANAGEMENT SYSTEM, AND METHODS OF USING THE SAME

(71) Applicant: Venkatesh B. VADLAMUDI, NOVI, MI (US)

(72) Inventor: Venkatesh B. VADLAMUDI, NOVI, MI (US)

(21) Appl. No.: 16/908,124

(22) Filed: Jun. 22, 2020

Related U.S. Application Data
(60) Provisional application No. 62/864,238, filed on Jun. 20, 2019.

(51) Int. Cl. G06Q 10/08; G06Q 30/00; G06Q 30/02; H04L 9/06; G06Q 50/02

(52) U.S. Cl. CPC G06Q 10/0833; G06Q 30/018; H04L 2209/38; H04L 9/0637; G06Q 50/02; G06Q 30/0206

(57) ABSTRACT

An integrated agriculture information and management system (AIMS system) for managing a produce from a farmer to a retailer, includes a central processing module including data management unit, analytics unit, business case making analysis unit, functionality unit, customer relationship management unit and financial unit; a harvesting module operable to provide information related to harvesting of produce to the central processing module; a vendors module for vendors including cold storage unit, pack house unit, processing center, distribution center, transportation unit and bankers unit, and a retailer module. The plurality of modules are augmented and integrated with at least one of blockchain technology, internet of things, artificial intelligence, customer relationship management, and application programming interface such that movement of the produce is recorded in real time and instantaneously, and when the produce is delivered to the retailer, the farmer and vendors are automatically paid for the produced delivered to the retailer.

### CROSS-REFERENCE TO RELATED APPLICATIONS

The present application claims priority under 35 USC § 119 to U.S. Provisional Patent Application No. 62/864,238, filed on Jun. 20, 2019. The entire subject matter of this priority document, including specification, claims and drawings thereof, is incorporated by reference herein.

### BACKGROUND OF THE INVENTION

### 1. Field of the Invention

The present invention relates to an integrated agriculture information management system (also referred to as dFarm product, dFarm system, AIMS system), and methods of using the same. More particularly, the present invention relates to an integrated agriculture information and management system, which is augmented and integrated with Blockchain technology, Internet of Things (IoT), and Artificial Intelligence (AI), etc. Using this technology together will be operable by selectively sharing agriculture industry information including produce, to manage agricultural produce from a number of farms, specifically small farms, to numerous retailers and consumers and to methods of using the same.

### 2. Description of Related Art

It has been recognized that, globally a total of about 1.3 billion tons, or one-third of the edible part of food originally intended for human consumption is wasted annually. Such wastage of food is estimated to cost nearly one trillion US Dollars ($1,000,000,000,000) per year. In addition, in the existing systems, the operational chain of selling produce from farmers to consumers requires an army of middlemen, agents and brokers, who mostly charge hefty commissions to farmers while dictating unfair prices to both the farmers and consumers. Moreover, in the existing systems, farmers and/or retailers/consumers are not equipped to track and trace the produce they are selling/buying. Farmers, specifically those who produce smaller quantities of produce, are definitely not equipped with or have no means to extend shelf life of their produce and must sell their harvest quickly or lose the much-needed revenue. In addition, many farmers rely heavily on the use of pesticides in large quantities mainly due to possible lack of good agricultural practices or farm management.

Another drawback of the existing system is that consumer prices are heavily inflated due to improper and inadequate systems implemented in dealing with agricultural produce by middlemen, e.g., brokers. For example, in developing countries like India, consumer prices are sometimes inflated by 500% to 2500% for agricultural produce, due to the lack of good solid agriculture information and having a strong farm management system in place.

A significant number of small and/or new farmers are unfavorably treated by lenders, such as banks, for loans they seek for implementation of advanced farming practices. For example, banks are reluctant to extend loans to small framers to use for advance farming practices, such as, hydroculture farming including hydroponic farming which involves a method of growing plants in mineral nutrient solutions in a water solvent without using soil. In general, banks are not able to assess farmers assurance of repayments of loans due to lack of efficient system for selling agricultural produce by farmers to retailers/consumers. Most of the times, small farmers are not able to produce authenticated documentation for advanced farming practices to secure loans from lenders due to lack of a robust, efficient system such as an integrated agriculture information and farm management system described herein, which would provide certification and/or documentation for loan applications and help the banks make favorable decisions.

Another drawback for existing agricultural produce system in most countries is that of corporate farming. It is well recognized that corporate farming has badly affected small, cottage farmers, who grows different, exotic varieties of agricultural produce. Small farmers are defined under US laws. For example, according to the USDA definition, a small farmer is defined as one that grows and sells agriculture produce between $1,000 and $250,000 per year. The applicant in the current system, considers a farmer being a small farmer who is not engaged in corporate farming. It may be noted that according to the U.S. Labor Department, the average age of farmers and ranchers is 58 years old and this age has been increasing over the last 30 years, according to the U.S. Department of Agriculture's Census of Agriculture. In view of this, nationally, ⅔ of all farmland will need a new farmer in just 15 to 20 years.

The present invention attempts to overcome the drawbacks of the existing agricultural information and management system. Accordingly, one of the benefits of the present invention is to provide a more efficient integrated agriculture information and management system (also referred to as dFarm product, dFarm system, AIMS system), augmented and integrated with blockchain technology, internet of things, and artificial intelligence, etc. Such a dFarm system would be operable to collectively and/or selectively share agricultural produce information and manage a number of operations including streamlining the pickup, transportation, logistics, storage, etc., of agricultural produce from numerous small farmers to numerous retailers and/or consumers. Also, the AIMS system would provide guidance to farmers on growing a variety of fruits, vegetables and processing thereof in a very efficient manner.

Another object of the present invention is to provide an integrated agriculture information and management system, which would promote improved agricultural practices by providing access to better forecasting, planning, improved produce quality, more efficient logistics, increased shelf life and better access to markets and better pricing. The present invention is aimed at improving the profitability of farming operations for small farmers, improving farmers' produce marketability in additional avenues, such as direct consumer marketing. Educating farmers to find answers to agriculture threats and weaknesses, will make farming activity a more viable business, supporting farm agencies and state agriculture departments, etc. dFarm would also contain a farmer's assistance module.

Furthermore, another object of the present invention is to provide an integrated agriculture information management system, which will enable farmers' access to extended value-added services on their produce and help make their farms run more efficiently and provide better faster and easier market access. Also, the dFarm system is configured to provide a value-added perspective of technology in agriculture and farming. In addition, the dFarm system would assist with a more efficient farming, to achieve significant reduction in farm produce wastage (which is a growing problem in today's world) using a more efficient routing of the produce to retailers and/or consumers. This faster market access also assures to the retailers to have the produce on their shelves longer for consumer to buy reducing spoilage/wastage. Next, the dFarm system of the present invention aims at assuring farmers a minimum viable price (MVP) for their produce by reducing steps or channels, e.g., numerous brokers involved in moving produce from the farms to retailers/consumers.

### SUMMARY OF THE INVENTION

The present invention according one aspect thereof provides an integrated agriculture information and management system for managing a produce from a farmer to a retailer. The integrated agriculture information and management system includes a plurality of modules including a central processing module comprising data management unit, analytics unit, business case making analysis unit, functionality unit, customer relationship management unit and financial unit; a harvesting module operable to provide information related to harvesting of produce to the central processing module; a vendors module comprising cold storage unit, pack house unit, processing center, distribution center, transportation unit and bankers unit, each operable to provide and seek information from the central processing unit; and a retailer module. The plurality of modules are selectively and operatively connected with each other, and each of the plurality of modules is augmented and integrated with at least one of blockchain technology, internet of things, artificial intelligence, the customer relationship management, and application programming interface such that movement of the produce is recorded in real time and instantaneously, and when the produce is delivered to the retailer, the farmer and vendors are automatically paid for the produced delivered to the retailer.

As indicated above, the dFarm product has integrated Blockchain business network including selectively and/or collectively shareable, replicable and immutable Blockchain technologies like hyperledger fabric. Furthermore, in the dFarm system, the IoT is integrated at different stages of operations using several connectivity options. The dFarm system is augmented and automated with AI.

The present invention according to another aspect thereof, provides the AIMS system having several modules including a central processing module including a central processing computer, a routine notification unit, an alarm device unit; a harvesting module comprising a farmer using a handheld device, a farm computer, a farm produce recording device; a bin bar coding module including a binning handheld device, movement of the agriculture produce, a barcode generating device, a printer; a first shipping and handling (first shipping) module including an environmentally controlled carrier, a first shipping handheld device; a cold storage module including a environmentally controlled structure; a processing module including a processing center, a first processing computer, a processing handheld device; a container bar coding module including a second shipping and handling module; a distribution module; a delivery module; a consumer module including a retailer module and a direct consumer module; a finance module including an integrated secure payment system. Various technologies such as Blockchain, IoT, AI, customer relationship management (CRM), application programming interface (API) etc., are associated with many different modules or different combination of modules.

The numerous modules are selectively and operatively connected with each other. The above-described system of another embodiment has a modular structure such that some modules may be removed, and/or additional modules may be added. The number of modules are operable to record the journey/movement of all agriculture produce from one point to the other and users of the systems can easily retrieve location information of the produce.

For a more complete understanding of the present invention, the reader is referred to the following, non-limiting, detailed description section, which describes an exemplary embodiment of the present invention and should be read in conjunction with the accompanying drawings. Such exemplary embodiment is provided for illustration and better understanding of the present invention and is not intended to limit the invention. Throughout the following detailed description and in the drawings, like numbers refer to like parts.

### BRIEF DESCRIPTION OF THE DRAWINGS

FIG. 1 shows outline of problem of existing produce selling system.

FIG. 2 shows a view of existing produce selling system adapted by small farmers.

FIG. 3 shows a AIMS operation model.

FIG. 4 shows outline of solution including application of a shared, replicated hyperledger.

FIG. 5 shows a view of the AIMS blockchain business network.

FIG. 6 shows AIMS blockchain participants and hyperledger.

FIG. 7 shows an illustration of a functioning internet of things.

FIG. 8 shows different internet of things (IoT) connectivity operations.

FIG. 9 shows an illustration of artificial intelligence (AI) in the AIMS.

FIG. 10 shows a view of selling and connecting system according to AIMS technology.

FIG. 11 shows another embodiment of the AIMS system.

### DETAILED DESCRIPTION

### Existing System

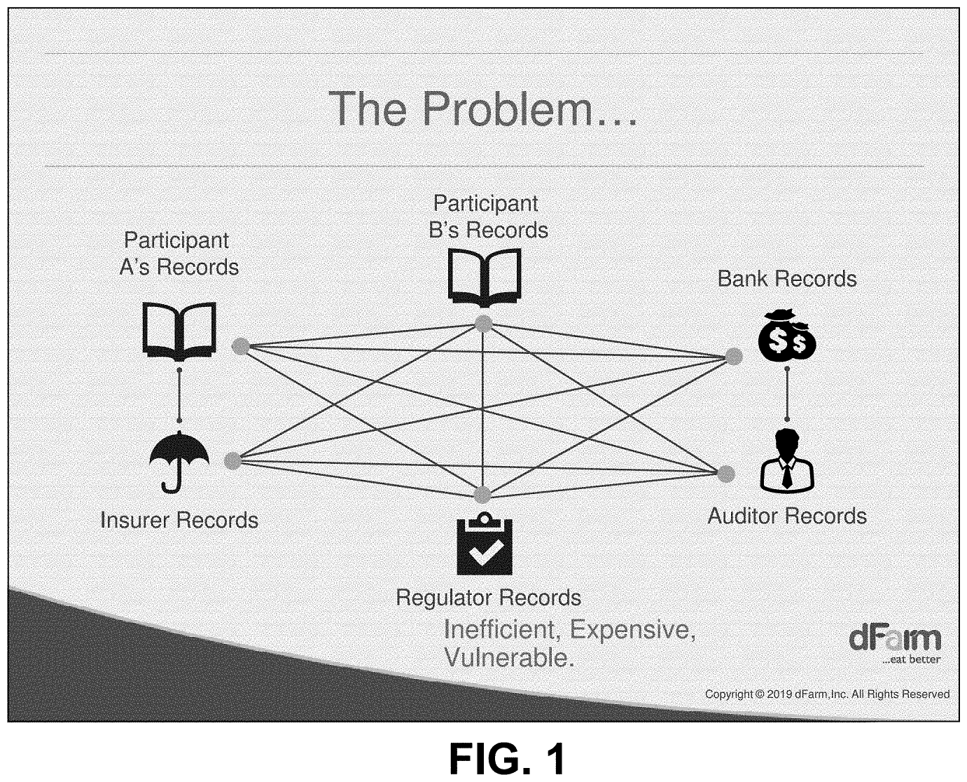

The existing system is inefficient, expensive and vulnerable to manipulation by participants using the system, and/or by external people. Such inefficient, expensive and vulnerable system E1 used for managing and selling produce is depicted in FIG. 1.

It can be noted based on FIG. 1 that the existing system does not have a trusted, replicated, hyperledger which has shared business process across all the members of the business network. Rather, it has only selectively shared business process among only a few participants of the business network. Moreover, the existing system lacks coordination and communication among the participants. Also, the existing system does not have internet of things integrated therewith for automatically tracing produce. Further, the existing system does not have artificial intelligence integrated with the system. Rather, for example, as shown in FIG. 1, the existing system has participant A's records PA, participant B's records PB, bank records BR, auditor records AR, regulator records RR and insurance records IR. Since these records do not have a common trusted and replicated hyperledger and/or are not modulated, the existing system is inefficient, expensive and vulnerable to security attacks.

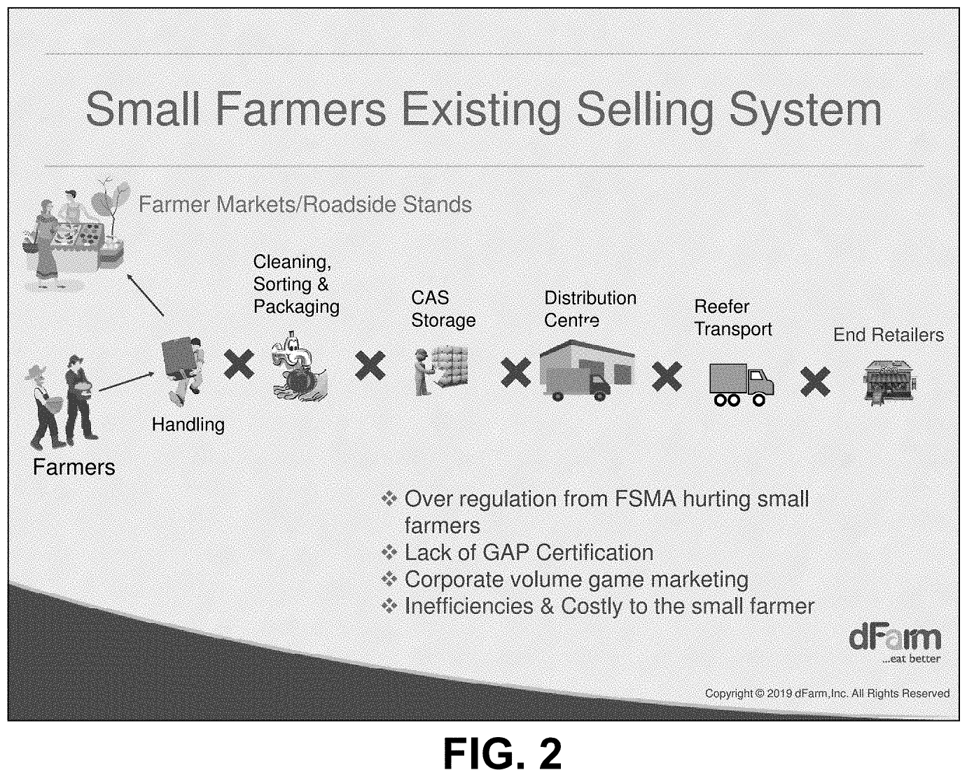

An existing selling system for small farmers' produce is illustrated in FIG. 2. In the existing selling system E2, there are several components which are not modulated and/or coordinated. Such components include famers providing and/or handing produce to famers markets/roadside stands.

It can be seen from FIG. 2 that the existing selling system lacks coordination and connectivity among various tasks involved in system, e.g., handling HS; cleaning CS, sorting SS and packaging PK, control Atmosphere storage CAS, distribution center DC, reefer transport RT, end retailers ER, etc. It may be noted that CAS is a storage mechanism in which fixed data is assigned a permanent location on a hard disk and addressed with a unique content name, identifier and/or address. Again, the system shown in FIG. 2 does not have integrated and/or augmented blockchain technology, internet of things and artificial intelligence.

It is generally recognized that over regulations, mostly government regulations, such as Good Agriculture Practice (GAP), Food Safety Modernization Act (FSMA) hurts small farmers. The FSMA has been effective since 2011. Under this Act, food companies including small farmers are required to develop food safety plans based on an evaluation of hazards related to food manufactured, processed, packed or held in all registered facilities. Furthermore, the most of the times small farmers cannot afford and/or lack good agricultural practices (GAP) certification. GAP was formally implemented by the United States Department of Agriculture (USDA) and Food and Drug Administration (FDA) in 2002. It is a voluntary audit program designed for the fruit and vegetable production industry to verify that the produce is grown, packed, handled, and stored as safely as possible. These audits check for adherence to the FDA's production guide and recognized industry food safety practices.

Moreover, the small farmers are unable to compete with big, corporate farms mainly due to corporate volume game marketing strategy. Overall, the existing system is inefficient and costly to small farmers and does not benefit small farmers.

### Integrated Agriculture Information and Management System

The present invention provides an integrated information and management system, which is also referred to as also referred to as dFarm product, dFarm system, AIMS system.

An outline of dFarm product of the present invention including its purpose, reference definitions, its scope summary, exemplary participants of the system/product, produce traceability, illustrative app screens, is provided in Annex-A, which was filed in applicant's provisional patent application U.S. Ser. No. 62/864,238, which is incorporated herein by reference.

A dFarm product presentation of this invention including objectives, illustrations of the dFarm product in detail are provided in Annex-B, which was filed in applicant's provisional patent application U.S. Ser. No. 62/864,238, which is incorporated herein by reference.

A dFarm product document of the present invention including brief information of the dFarm product and various modules of the system including farm management, inventory and warehouse, logistics, business to business modules, finance, admin, technology, etc., is provided in Annex-C, which was filed in applicant's provisional patent application U.S. Ser. No. 62/864,238, which is incorporated herein by reference.

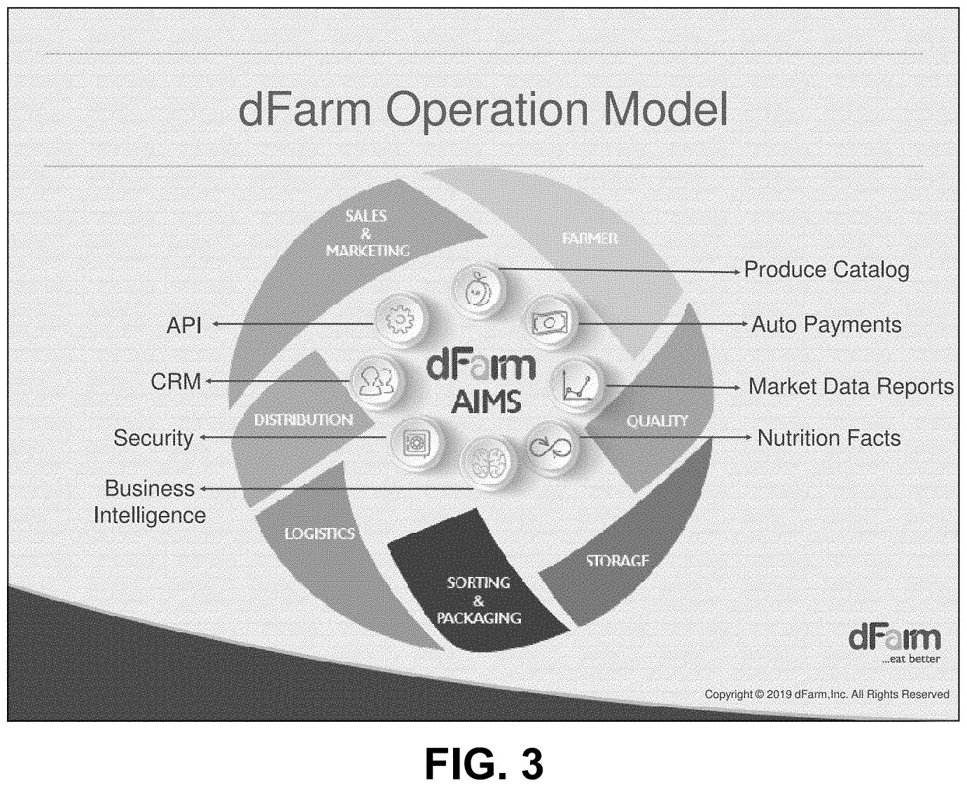

The dFarm operation model is shown in FIG. 3. The operation model includes a number of modules, such as produce catalog PC, automatic payments AP, market data reports MDR, nutritional facts NF, business intelligence BI, security S, customer relationship management CRM, application programming interface API, etc. These modules are appropriately coordinated for various functions including farmer offering farm produce before or after actual harvesting of the produce, quality assurance, storage needs, sorting and packaging, logistics, distribution and sales and marketing.

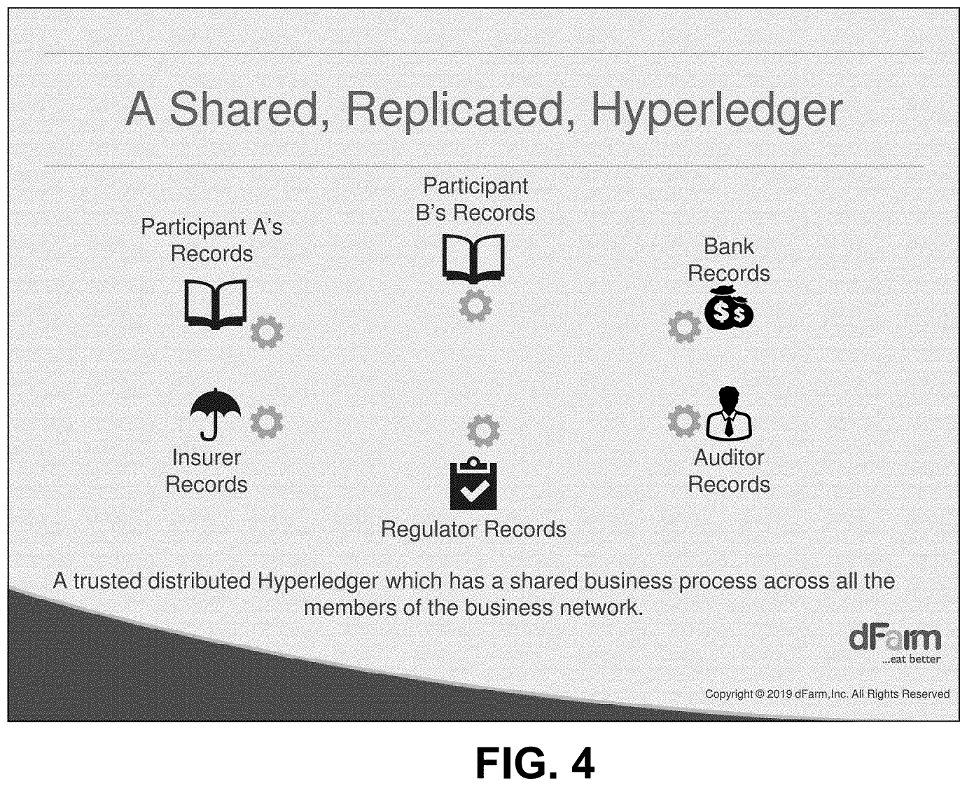

As show in FIG. 4, the present invention provides the dFarm system augmented with the information technology having a trusted distributed hyperledger fabric HF which has shared business processes in its entirety across all the members of the business network, e.g., participant A's records PA, participant B's records PB, bank records BR, auditors record AR, regulatory records RR, and insurer records IR. The dFarm system is configurable such that the hyperledger fabric HF may be shared only with a few selected members. Also, such a technology has a shared, replicated hyperledger fabric that is accessible to a few selected or to all the members of the business network during its process.

It may be noted that hyperledger fabric HF is a permissioned blockchain infrastructure providing a modular architecture with a delineation of roles between the nodes in the infrastructure, execution chaincodes in fabric and configurable consensus and membership services. A fabric network include peer nodes, which execute chaincode, access ledger data, endorse transactions and interface with applications. Orderer nodes which ensure the consistency of the blockchain and deliver the endorsed transactions to the peers of the network, and Membership Service Providers (MSPs), generally implemented as a Certificate Authority.

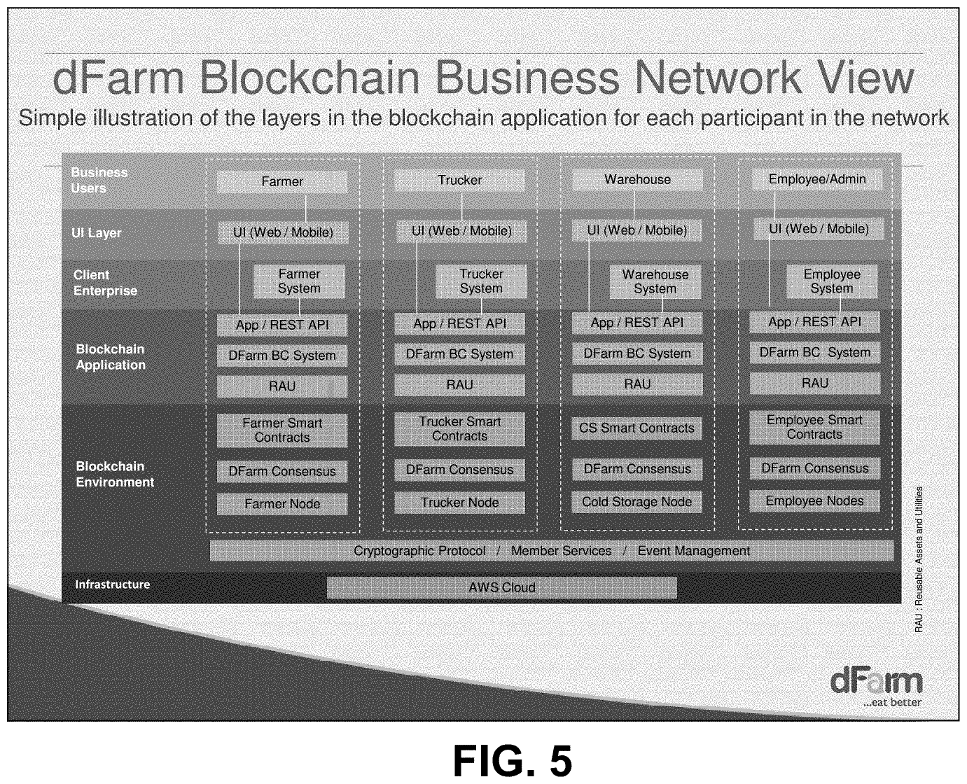

The dFarm product has integrated a Blockchain business network. A typical view of dFarm blockchain business network is shown in FIG. 5. The main layers in blockchain are business users, user interface (UI) layer, client enterprise, blockchain application and blockchain environment. As shown in FIG. 5, each of the layers includes several components. For example, business users layer include: the farmer, trucker, warehouse and employee/admin. The client enterprise includes a farmer system, a trucker system, a warehouse system and an employee system.

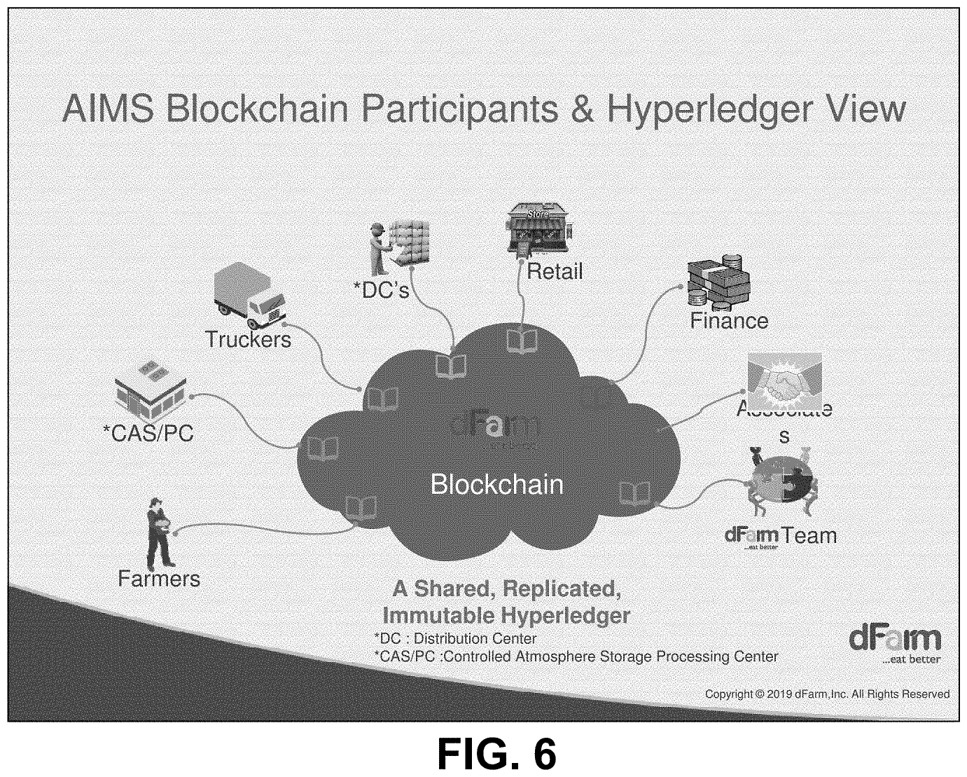

According to the dFarm system of the present invention, participants in the system are connected with each other through a shared, replicated, immutable hyperledger fabric created by using the blockchain technology. An example of such a connectivity of the participants via application of blockchain technology in the dFarm system is shown in FIG. 6. As it can be seen from FIG. 6, a shared, replicated and immutable hyperledger HF is shared with farmers, storage (CAS/PC), truckers, distribution centers (DC), retailers, finance, accounts and dFarm team.

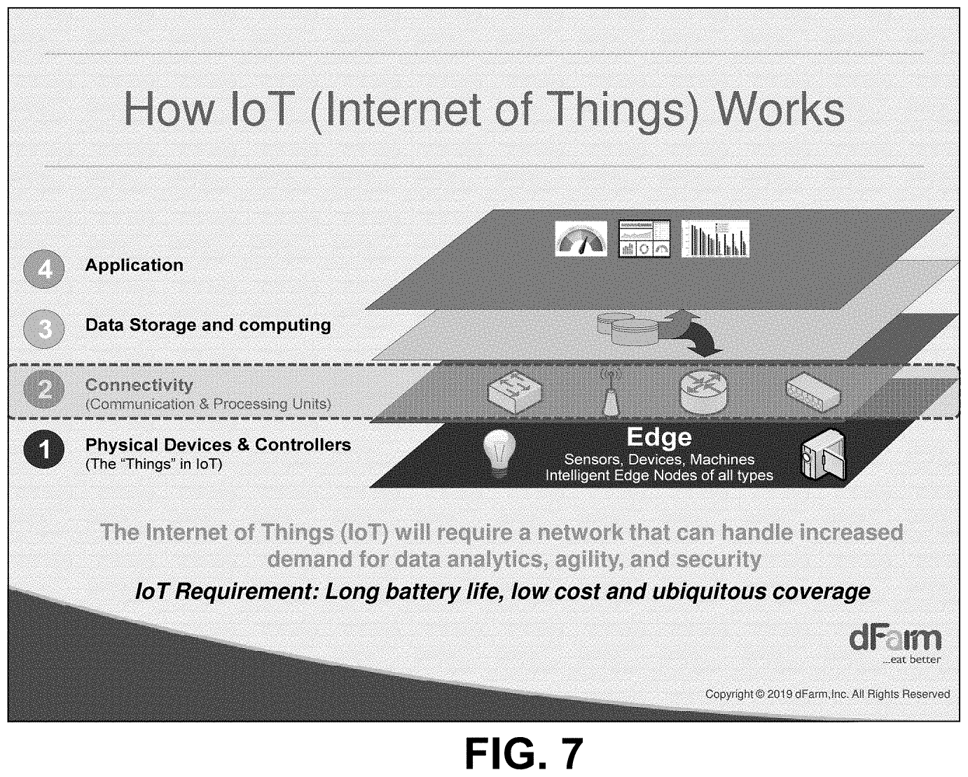

Furthermore, in the dFarm system, the Internet of Things (IoT) is integrated at different stages. The IoT is the extension of internet connectivity into physical devices and everyday objects. The IoT equips with devices that can communicate and interact with others over the Internet, and they can be remotely monitored and controlled. The IoT generally requires a network that can handle increased demand for data analytics, agility and security. Other IoT requirements are long battery life, low cost and ubiquitous coverage. An illustration of how IoT works is provided in FIG. 7. The IoT technology is most synonymous with products pertaining to this concept are smart devices and appliances, e.g., thermostats, lighting fixtures, home security systems and cameras, refrigerators, etc. They also support one or more common ecosystems, such as smart phones. In the present system, the application of IoT may be extended to packaging, storage bins and containers containing the farmer's produce.

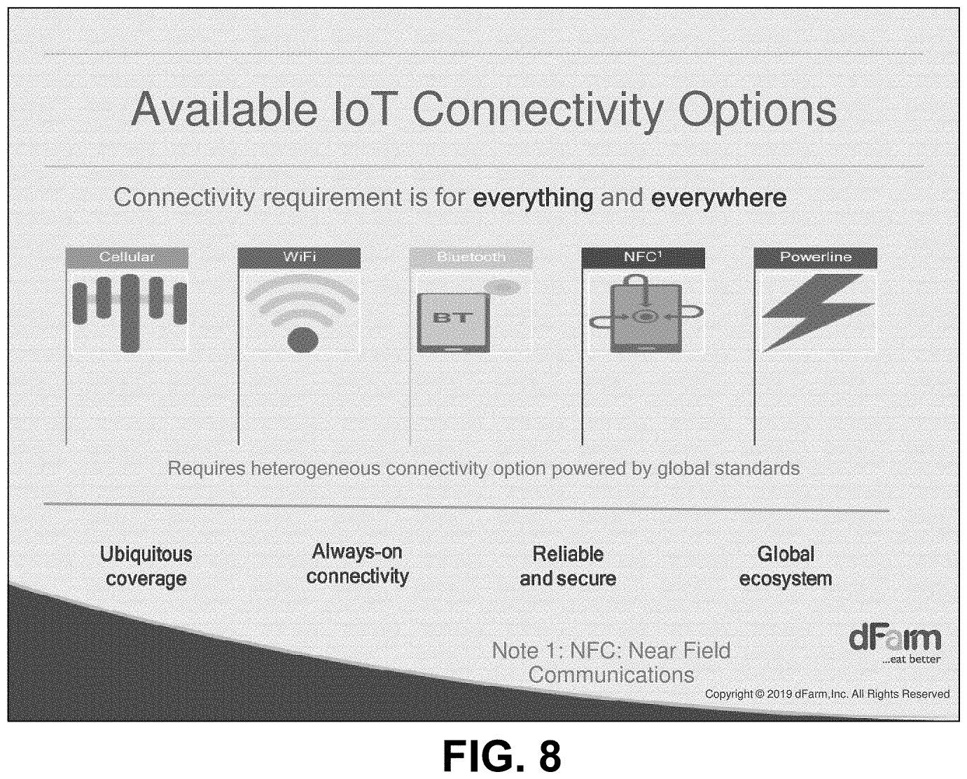

There are several IoT connectivity options used in the dFarm system. Examples of such connectivity options include: Cellular, WiFi, Bluetooth, Near Field Communications (NFC) and power lines. Such connectivity options are shown in FIG. 8. The dFarm system is further configurable to add additional new connectivity options or using a combination of options that is listed above.

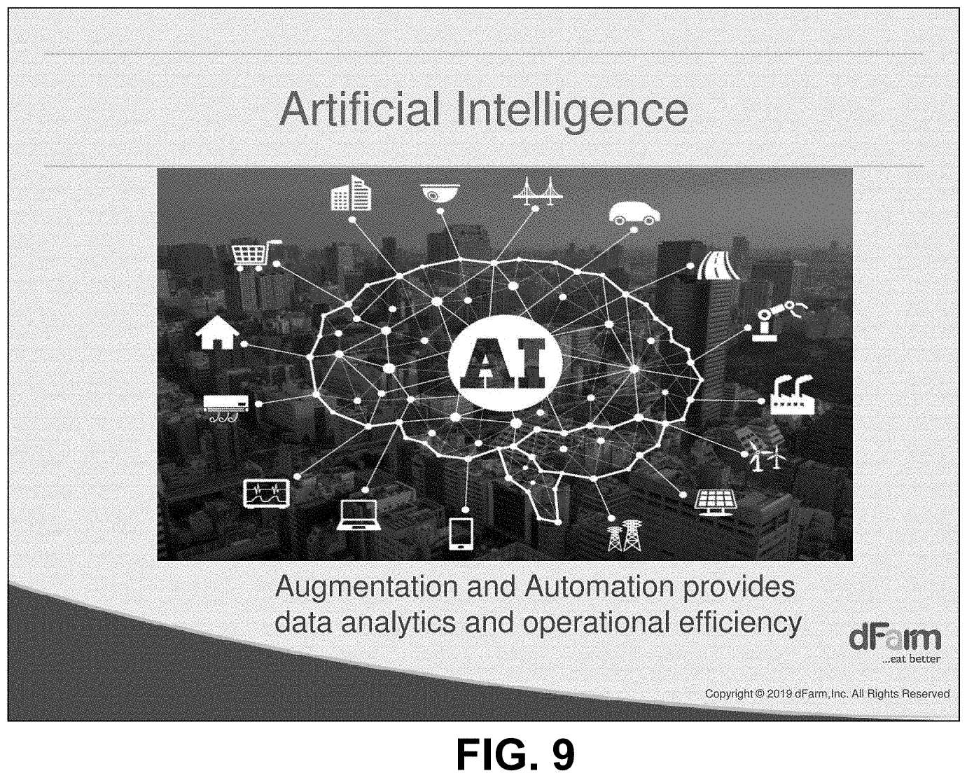

Next, the dFarm system is augmented with Artificial Intelligence (AI). This augmentation and automation of the dFarm system provides faster data analytics and operational efficiency for tracing logistics of agriculture produce. A general illustration of AI augmented with the dFarm system is shown in FIG. 9. AI which is a machine intelligence is used to describe machines/computers that mimic “cognitive” functions that humans associate with other human minds, such as, learning and problem solving at a much faster speed.

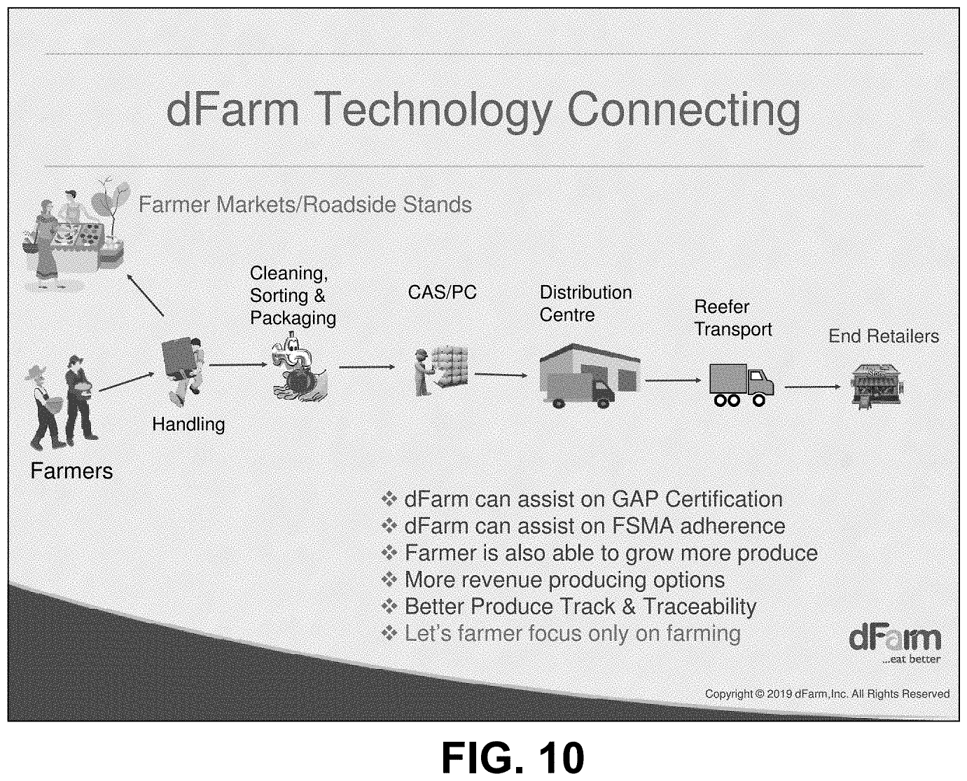

The present invention including the dFarm product provides efficient and reliable/replicable connectivity among various participants involved in the produce producing and selling system. FIG. 10 generally shows efficient movement of produce from small farmer to end retailers and consumers. In addition, the dFarm system is operable to and/or configurable to procure GAP certification and to provide assistance to comply with FSMA. Since the farmers have to spend less time on technical requirements of procuring GAP certification and/or complying with FSMA and also spend less time on selling his produce, farmers are able to grow more produce, have more revenue producing options, have better produce track and traceability and spend more time on actual core farming activity. The actual core farming activity is the activity, which is what farmers do best.

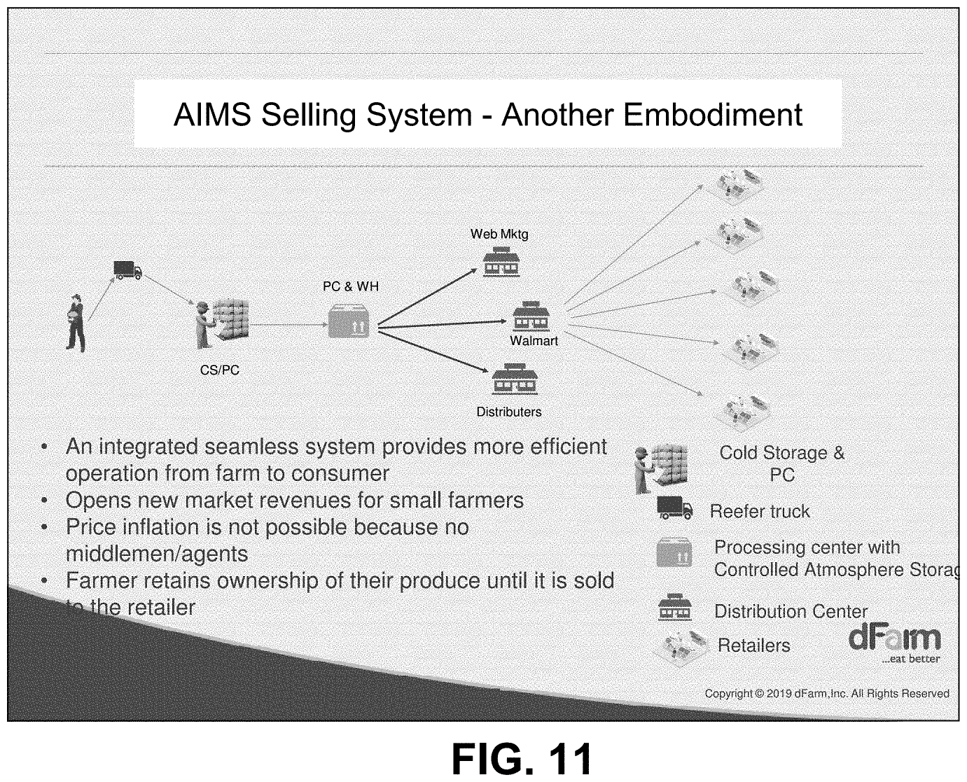

Another embodiment of dFarm selling system is shown in FIG. 11. This system is integrated into a seamless system that provides more efficient operation from farm to consumer, opens new market revenues for small farmers, minimizes/prevents price inflation due to elimination of middlemen/agents. Moreover, the farmers retain produce ownership and track it produce throughout this process until it is sold to the retailers.

Additional embodiments and details of the present invention are outlined in the attached Appendix-I, Appendix-II, Appendix-III and Appendix-IV, each of which is incorporated herein by reference.

Although the present invention has been described herein with respect to several specific illustrative embodiments, the foregoing description is intended to illustrate, rather than to limit the invention. Those skilled in the art of IT will realize that many modifications of the illustrative embodiment can be made and would be operable. All such modifications, which are within the scope of the claims are intended to be within the scope and spirit of the present invention.

What is claim is:

1. An integrated agriculture information and management system for managing a produce from a farmer to a retailer, said integrated agriculture information and management system comprising a plurality of modules including
a central processing module comprising data management unit, analytics unit, business case making analysis unit, functionality unit, customer relationship management unit and financial unit;
a harvesting module operable to provide information related to harvesting of produce to the central processing module;
a vendors module for vendors comprising cold storage unit, pack house unit, processing center, distribution center, transportation unit and bankers unit, each operable to provide and seek information from the central processing unit; and
a retailer module;
wherein the plurality of modules are selectively and operatively connected with each other, and each of the plurality of modules is augmented and integrated with at least one of blockchain technology, internet of things, artificial intelligence, the customer relationship management, and application programming interface such that movement of the produce is recorded in real time and instantaneously, and when the produce is delivered to the retailer, the farmer and vendors are automatically paid for the produced delivered to the retailer.

2. The integrated agriculture information and management system according to claim 1, wherein the central processing module comprises a central processing computer, a routine notification module and an alarm device;
wherein the central processing module is operable to control functionality of each of the modules; and
wherein each of the modules is operable to request the central processing module to configure functionality of the one or more of the modules.

3. The integrated agriculture information and management system according to claim 1, wherein the harvesting module comprises a farm computer, a handheld device operably connected to the farm computer, and a recording device connected to the farm computer.

4. The integrated agriculture information and management system according to claim 1, wherein the cold storage unit includes a environmentally controlled structure adapted to store and secure the produce;

5. The integrated agriculture information and management system of claim 1 is configured such that each of the modules is custom programmable.

6. The integrated agriculture information and management system of claim 1 is configured such that at least one of the modules is replaceable.

7. The integrated agriculture information and management system according claim 1, wherein the blockchain technology comprises an integrated blockchain network including hyperledger fabric, which is selectively and/or collectively sharable, replicable and immutable at said plurality of modules.

8. The integrated agriculture information and management system according claim 1, wherein each of the modules includes at least one physical device; and wherein the internet of things is operable to connect the physical devices such that said devices interact and communicate with each other over an internet connection and the devices are remotely monitored and controlled.

9. The integrated agriculture information and management system according claim 1, wherein each of the modules includes at least one physical device; and wherein the internet of things is operable to connect the physical devices such that said devices interact and communicate with each other over an internet connection via one of connectivity methods including cellular, wireless fidelity, bluetooth, near field communication, electric power lines.

10. The integrated agriculture information and management system according claim 9, wherein said devices are operable to be monitored and controlled remotely.

11. An integrated agriculture information and management system for managing plurality of produce from a plurality of farmers to plural retailers, said integrated agriculture information and management system comprising a plurality of modules including
a central processing module comprising data management unit, analytics unit, business case making analysis unit, functionality unit, customer relationship management unit and financial unit;
a harvesting module operable to provide information related to harvesting of produce to the central processing module;
a vendors module for vendors comprising cold storage unit, pack house unit, processing center, distribution center, transportation unit and bankers unit, each operable to communicate with the central processing module; and
a retailer module;
wherein the plurality of modules are selectively and operatively connected with each other without intermediaries, and each of the plurality of modules is augmented and integrated with at least one of blockchain technology, internet of things, artificial intelligence, customer relationship management, and application programming interface such that movement of the produce is tracked and traced in real time and instantaneously.

12. The integrated agriculture information and management system according to claim 11, wherein the intermediaries include at least one of middlemen, brokers and agents.

13. The integrated agriculture information and management system according to claim 11, wherein the central processing module is configured to record all transactions and operable to produce a certification of the transactions including proceeds from farm produce sales for a predetermined time period for each respective said farmers.

14. The integrated agriculture information and management system according to claim 11, wherein the central processing module is configured to produce guidance on demand to the farmers on growing a variety of produce and processing thereof, produce marketability, and minimum viable price for the produce.

15. The integrated agriculture information and management system according to claim 11, wherein the finance unit is configured to make automatic payments to the farmer and the vendors upon receipt and acceptance of produce by the retailer.

16. The integrated agriculture information and management system according to claim 11, wherein the blockchain technology comprises an integrated blockchain network including hyperledger fabric, which is selectively and/or collectively sharable, replicable and immutable at said plurality of modules.

17. The integrated agriculture information and management system according to claim 11, wherein each of said plurality of modules is configured to selectively and operatively connect with a plurality of handheld devices.

18. The integrated agriculture information and management system according to claim 11, wherein the central processing module is configured to produce guidance on demand to the farmers on good agricultural practices (GAP) so as to verify that the produce is grown, packed, handled and stored according to the United States Department of Agriculture guidelines without causing or minimally causing contamination thereof.
